(19) United States
(12) Patent Application Publication
(10) Pub. No.: US 2023/0392862 A1
(43) Pub. Date: Dec. 7, 2023

(54) KRYPTON RECOVERY AND PURIFICATION FROM CUSTOMER PROCESSING

(71) Applicants: Neil M. Prosser, Lockport, NY (US); Richard D. Lenz, Tonawanda, NY (US)

(72) Inventors: Neil M. Prosser, Lockport, NY (US); Richard D. Lenz, Tonawanda, NY (US)

(21) Appl. No.: 17/833,990

(22) Filed: Jun. 7, 2022

(51) Int. Cl. F25J 3/02; F25J 5/00; F25J 3/08; F25J 1/00

(52) U.S. Cl. CPC F25J 3/028; F25J 5/005; F25J 2215/34; F25J 1/0072; F25J 3/08

(57) ABSTRACT

Embodiments of a krypton recovery method and apparatus are provided. The method and apparatus involves removing contaminants from a krypton containing waste gas to yield a krypton containing effluent gas; compressing and cooling the krypton containing effluent gas to yield a nearly saturated vapor krypton containing effluent. The krypton containing vapor effluent.is partially condensed in a reboiler and the resulting stream is rectified in a crude distillation column to yield the crude krypton. The crude krypton to further refined is a separate cryogenic distillation system and process to produce a refined krypton product.

### TECHNICAL FIELD

The present invention relates generally to purification, and more particularly, to a distillation method and apparatus for krypton recovery and purification.

### BACKGROUND

There is rising global demand for rare gases such as krypton and xenon due to limited supply and the rapid growth of use for such rare gases by customers such as electronics fab shops. Many of these electronics fab shops use krypton in their etching process, which after use is vented at a concentration approximately 1000 times higher than that of air and with a balance of primarily nitrogen.

The rising demand and increasingly challenging supply have caused recovery of krypton from electronics fab shop exhaust streams to be economically advantageous. While many adsorption-based purification methods have been developed and are needed to remove contaminants from exhaust streams of such electronics fab shops such as those described in U.S. patent application Ser. No. 17/552,869; these prior art purification methods lack the ability to recover krypton gas.

Therefore, there is a need for an alternate process to remove contaminants and recover krypton from exhaust streams of electronics fab shops. More specifically, there is a need for an economically viable distillation based method that enables the recovery and production of high purity krypton from exhaust streams of electronics fab shops or other customers, in order to better conserve much-needed krypton gas.

### SUMMARY

The present system and methods address the above-mentioned problems and/or disadvantages and provides a distillation-based process or method that enables the recovery of crude krypton and the production of high purity krypton from the exhaust streams of electronics fab shops or other customers.

An aspect of the present krypton recovery method is to provide a two-step or two-part method. The first part of this two-part process is designed to take a waste gas stream from a customer facility and refine it using a cryogenic distillation process to produce crude krypton having about 70% krypton at the customer site. More specifically, the first part of the two-part krypton recovery method comprises the steps of: (i) removing contaminants from a krypton containing waste gas to yield a krypton containing effluent gas; (ii) compressing the krypton containing effluent gas; (iii) cooling the compressed, krypton containing effluent gas in a first heat exchanger to yield a saturated vapor or nearly saturated vapor krypton containing effluent; (iv) at least partially condensing the saturated vapor or nearly saturated vapor krypton containing effluent in a reboiler against a krypton containing liquid to produce an at least partially condensed krypton containing fluid and an ascending vapor stream for a crude distillation column; (v) directing the at least partially condensed fluid from the re-boiler to an upper location of the crude distillation column; (vi) rectifying the at least partially condensed fluid in the crude distillation column to yield the krypton containing liquid at the bottom of the crude distillation column and an overhead; and (vii) extracting crude krypton from krypton containing liquid bottoms in the crude distillation column. The second part of the two-part process is to refine the crude krypton at a different site, such as a small, centralized krypton plant or column for final purification before reselling the krypton to the market.

In accordance with another aspect of the disclosure, a krypton recovery apparatus is provided that comprises a purifier, compressor, first heat exchanger, a crude distillation column, a reboiler (preferably disposed in the crude distillation column), and a krypton refining system.

The purifier is preferably an adsorption based purifier configured for removing contaminants from a krypton containing waste gas to yield a krypton containing effluent gas. The compressor is configured for compressing the krypton containing effluent gas which is cooled in the first heat exchanger to yield a saturated vapor or nearly saturated vapor krypton containing effluent. The reboiler is configured to partially condense the saturated vapor or nearly saturated vapor krypton containing vapor effluent against a krypton containing liquid to produce an at least partially condensed, krypton containing fluid and an ascending vapor stream. The crude distillation column is configured to receive the ascending vapor stream and the at least partially condensed, krypton containing fluid and to rectify the at least partially condensed, krypton containing fluid to yield the krypton containing liquid and an overhead. Lastly, the krypton refining system is configured to receive crude krypton from the crude distillation column and produce a refined krypton product.

Both the above-described krypton recovery method and the krypton recovery apparatus both contemplate cooling the compressed, krypton containing effluent gas in the first heat exchanger via indirect heat exchange against a waste gas extracted from the overhead from the crude distillation column. A source of liquid nitrogen may be added to the crude distillation column, as necessary to enhance the rectification process within the crude distillation column.

The krypton refining system and the step of refining the crude krypton to produce the refined krypton product further comprises feeding the crude krypton into a second heat exchanger configured to cool the crude krypton via indirect heat exchange with one or more cold gas streams in the second heat exchanger. The krypton refining system and method also includes a refining column configured to produce a refined krypton bottoms and a refining column overhead as well as a condenser configured to condense a portion of the refining column overhead to produce a refining column reflux stream and optionally one of the one or more cold gas streams. Also, another portion of the refining column overhead may also be directed to the second heat exchanger as another of the one or more cold gas streams. An electric reboiler is disposed within the refining column to re-boil a portion of the refined krypton bottoms to produce an ascending vapor stream in the refining column while another portion of the refined krypton bottoms is then purified to remove additional contaminants and yield a refined krypton product. The refined krypton product is then compressed in an auxiliary compressor and the compressed, refined krypton product is used to fill one or more product containers.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 schematically illustrates an embodiment of the present krypton recovery method;

FIG. 2 is a graph illustrating crude column fluid conditions versus krypton (in nitrogen) melting point data according to an embodiment of the present krypton recovery method;

FIG. 3 is a graph illustrating feed compressor power vs. crude distillation column product purity, according to an embodiment of the present krypton recovery method;

FIG. 4 is a graph illustrating the fluid composition vs. temperature profile compared to the melting point curve, according to an embodiment of the present krypton recovery method;

FIG. 5 illustrates the krypton recovery method of FIG. 1 without conversion of crude krypton to gas, according to an embodiment of the present krypton recovery method; and

FIG. 6 illustrates a unified location krypton recovery method, according to an embodiment.

### DETAILED DESCRIPTION

Embodiments of the present disclosure will be described herein below with reference to the accompanying drawings. However, the embodiments of the disclosure are not limited to the specific embodiments and should be construed as including all modifications, changes, equivalent devices and methods, and/or alternative embodiments of the present disclosure. Descriptions of well-known functions and/or configurations will be omitted for the sake of clarity and conciseness.

The expressions “have,” “may have,” “include,” and “may include” as used herein indicate the presence of corresponding features, such as numerical values, functions, operations, or parts, and do not preclude the presence of additional features. The expressions “A or B,” “at least one of A or/and B,” or “one or more of A or/and B” as used herein include all possible combinations of items enumerated with them. For example, “A or B,” “at least one of A and B,” or “at least one of A or B” indicate (1) including at least one A, (2) including at least one B, or (3) including both at least one A and at least one B.

Terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may indicate different user devices regardless of the order or importance. A first element may be referred to as a second element without departing from the scope the disclosure, and similarly, a second element may be referred to as a first element.

When a first element is “operatively or communicatively coupled with/to” or “connected to” another element, such as a second element, the first element may be directly coupled with/to the second element, and there may be an intervening element, such as a third element, between the first and second elements. To the contrary, when the first element is “directly coupled with/to” or “directly connected to” the second element, there is no intervening third element between the first and second elements.

All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the disclosure.

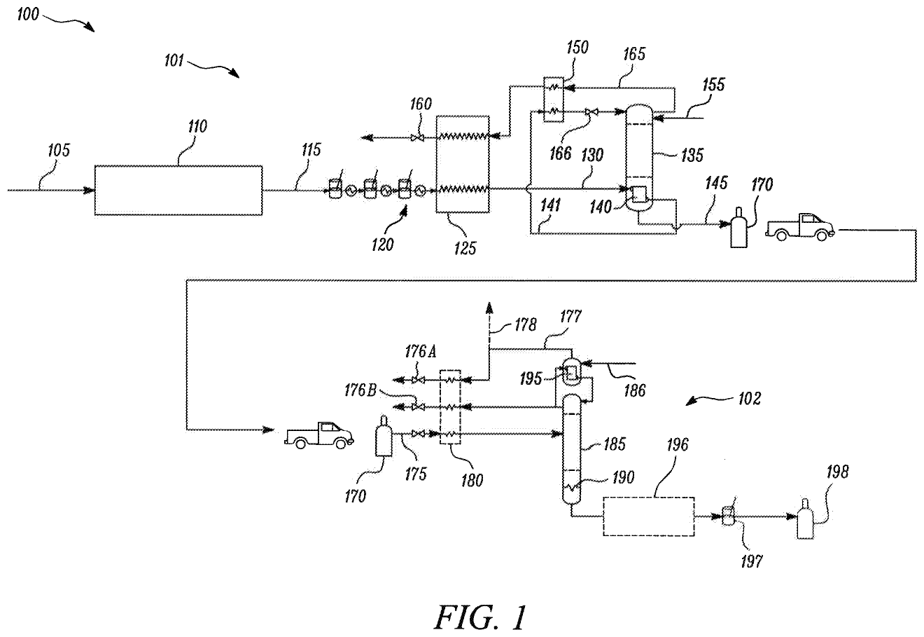

Turning to FIG. 1, there is shown an embodiment of the present krypton recovery method and apparatus. Waste gas 105 from a customer facility such as chip manufacturing site contains rare gases such as krypton and xenon but is also typically contaminated with fluorinated compounds and carbon monoxide (CO). The contaminants as well as the xenon gas are removed in a warm end removal and purification process 110 that is generally described in U.S. patent application Ser. No. 17/552,869, the disclosure of which is incorporated by reference herein. Although this adsorption based purification systems may be broadly applied to a krypton rich gas for removal of the contaminants, the temperature-swing adsorption process described in the prior art is generally ineffective for upgrading the krypton concentration.

In FIG. 1, after the warm end contaminant removal process 110 is performed, the krypton containing effluent gas 115 has a concentration range of broadly about 100-2000 parts per million (ppm) krypton with balance of mainly nitrogen and some oxygen, or more specifically in the range of about 200-1000 ppm krypton with balance of nitrogen and oxygen. Trace amounts of fluorinated impurities may remain in the effluent stream 115 after the contaminant removal process 110, although complete removal is intended. Also, up to about 2% oxygen may also be contained in the krypton containing effluent gas due to some excess addition in the contaminant removal process 110. Small quantities of hydrogen, carbon monoxide, argon and methane will generally be removed in contaminant removal process 110.

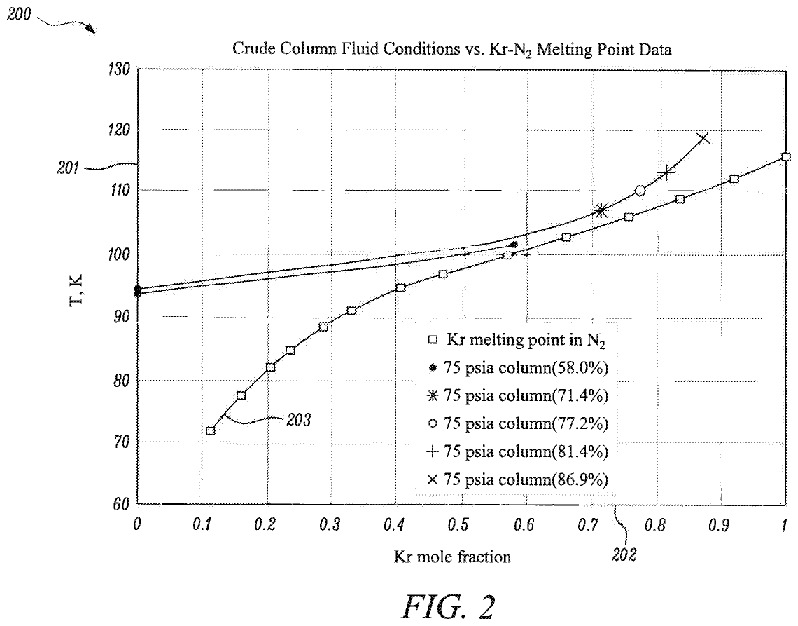

Handling of any oxygen in the feed is not difficult, so long as the oxygen concentration is not highly variable, as will be described in reference to FIG. 2. Other potential contaminants not completely removed in the pre-processing warm end contaminant removal process 110 that are also not removed in this process, so long as they are low in concentration, will be removed by the post processing contaminant removal process 196.

The krypton containing effluent gas 115 is preferably near ambient temperature and near ambient pressure. The krypton containing effluent gas 115 is compressed to sufficient pressure in the feed compressor arrangement 120 which is designed or tailored to the feed flow and pressure. Special seals or a seal gas recovery system may be incorporated in the feed compressor arrangement 120 to minimize the leakage of the highly valuable krypton gas. For the typical size anticipated, a positive displacement compressor may be used. A multi-stage reciprocating compressor with intercoolers and aftercoolers is shown in FIG. 1.

To recover the krypton from the krypton containing effluent gas, the present system and method employs a cryogenic distillation process. Due to the vast difference in boiling points and relative volatilities, krypton can be easily separated from the nitrogen and oxygen in a crude distillation column 130. The distillation column arrangement includes a reboiler 140 disposed within the crude distillation column 135. A vital feature in this process is the conditioning (i.e. temperature and pressure) of the feed gas 130 being utilized to drive the reboiler 140 which, in part, depends on the pressure of the crude distillation column 135 and the purity of the crude krypton 145. However, a key challenge in in designing the cryogenic distillation cycle is to accomplish the separation or rectification while avoiding freezing of the fluid.

Higher column pressure and higher purity require a higher pressure feed stream in order to have an appropriate change in temperature (ΔT) in the reboiler 140. However, higher pressure also causes more power consumption and possibly a more expensive feed compressor arrangement 120. Also, as the feed stream approaches its critical pressure (e.g. about 490 pounds per square inch absolute (psia)), the latent heat of the feed sharply decreases and the re-boiling then depends more on sensible heat. The feed stream pressure should be well below the critical pressure. The column pressure must also be sufficiently high to avoid the possibility of freezing in the column, the column sump, or the downstream product piping. This is further discussed in relation to FIG. 2.

The compressed, krypton containing effluent gas is cooled in a main heat exchanger 125 to yield a saturated vapor or nearly saturated vapor, krypton containing effluent feed stream 130. The krypton containing vapor effluent feed stream 130 exiting heat exchanger 125 is preferably a nearly saturated vapor, likely slightly superheated. Liquid at the base of crude distillation column 135 is boiled in the reboiler 140 against this krypton containing vapor effluent feed stream 130. Exiting the reboiler 140, the krypton containing stream 141 is at least partially condensed. The krypton containing stream 141 exiting the reboiler is a saturated liquid or may be slightly subcooled or very slightly two phase mixture.

The krypton containing stream 141 is then subcooled in a subcooler heat exchanger 150 against the waste gas 165 or overhead exiting the top of the crude distillation column 135. Although shown as a separate heat exchanger, the subcooler 150 may be combined in an integrated heat exchanger together with the main heat exchanger 125.

The subcooled krypton containing liquid exiting subcooler 150 is decreased in pressure to the column pressure through a throttle valve 166 and is fed to the top of the crude distillation column 135 as a reflux stream. A small liquid nitrogen stream 155 may also be fed to the top of the crude distillation column 135, as needed. This liquid nitrogen add provides some of the refrigeration that may be needed for the cryogenic distillation cycle. Within the crude distillation column 135, the fed streams are rectified to yield a krypton containing liquid at the bottom of the crude distillation column 135 and a nitrogen-rich overhead. A portion of krypton containing liquid at the bottom of the crude distillation column 135 is taken as crude krypton 145 and placed in crude krypton product containers 170. The remaining portion of the krypton containing liquid is boiled by the reboiler 140. This ascending vapor from the reboiler 140 is much lower in krypton composition than the crude krypton 145 because of the high relative volatility difference between krypton and the other constituents such as nitrogen and oxygen in the krypton containing liquid.

The crude distillation column can use structured packing of a number of types, or trays. Between 3 and 6 theoretical stages of separation are preferred for the crude distillation column, resulting in krypton recovery greater than about 90%.

The nitrogen-rich overhead is extracted from the top of the crude distillation column as a saturated vapor and is almost pure nitrogen, although it may also contain a small amount of unrecovered krypton. The extracted nitrogen-rich overhead is a waste gas 165 which is then superheated in the subcooler 150 via indirect heat exchange against the krypton containing stream 141 and is then further warmed to about ambient temperature in the main heat exchanger 125 via indirect heat exchange against the compressed, krypton containing effluent gas feed.

A valve 160 is disposed at the warm end of the main heat exchanger 125 to decrease the pressure of the waste gas 165 before it is vented to atmosphere. The valve 160 can be configured as a control for the cryogenic distillation cycle and is preferably disposed at the warm end as a most cost-effective construction and to enable easy access to the valve 160 for maintenance purposes. This construction or arrangement also precludes a diminished refrigeration benefit and reduction in liquid nitrogen 155 addition if this valve 160 were instead located either between the crude distillation column 135 and the subcooler 150 or between the subcooler 150 and the main heat exchanger 125.

The crude krypton product containers 170 can be liquid containers or the crude krypton 145 can be converted to crude krypton gas. High pressure is desirable when the crude krypton is stored as gas. This can be accomplished by feeding the product as liquid into a container and warming it, so that the resulting gas is of a suitable pressure. Alternatively, the product liquid can be directly warmed and vaporized, and then compressed into gaseous containers.

The crude krypton product containers 170 can then be shipped by any suitable method, such as by truck in FIG. 1, to a separate processing site (krypton refinery 102) where refined krypton product is made. Subsequently, crude krypton from one or more on-customer site crude krypton recovery units 101 will be fed to a krypton refinery 102 where the proper quality assurance and quality control (QA/QC) methods and procedures can be adhered to, thereby ensuring that product specifications are maintained.

Since the waste gas 105 feed to the crude krypton recovery units 101 contains nominally 1000 ppm krypton and the crude krypton 145 feed to the krypton refinery 102 contains approximately 70% krypton, the feed flow to the krypton refinery 102 is decreased, even if it is sourced from multiple crude units. In other words, the krypton refinery 102 may not run continuously due to the low volume of the crude krypton feed.

The illustrated krypton recovery system and method illustrated in FIG. 1 specifically concerns situations when the crude krypton 145 is delivered to the krypton refinery 102 as a gas. The crude krypton feed 175 to the krypton refinery 102 is decreased in pressure and is then cooled against returning cold gases in the optional heat exchanger 180.

Without the optional heat exchanger 180, ambient temperature crude krypton feed 175 is fed directly to the refining column 185. The effect of ambient temperature (i.e. excessively superheated) crude krypton feed directly to the refining column 185 is to vaporize a portion of the downflowing liquid. In effect, this vaporized liquid is “short circuited” from providing reflux below the vapor feed point. The result is that a greater liquid nitrogen 186 flow is needed to provide more duty for the condenser 195 when the system is designed with an ambient temperature crude krypton feed directly to the refining column 185.

The high superheat of ambient temperature crude krypton feed 175 may also create some localized undesirable effects in the refining column 185. For example, a packed column may have a zone of non-wetted packing due to the vaporization of downflowing liquid. A trayed column may even have uneven liquid level or even partial drying out of the tray above the feed. The refining column design must consider these effects. However, a practical refining column design may have a high enough volume relative to the low feed flow that the liquid and vapor flows internal to the refining column overwhelm the feed flow, such that the negative impacts of the superheated feed are minor. Thus, the liquid nitrogen 186 flow to the condenser 195 and the reboiler 190 duty are significantly higher than they otherwise would be. However, this flow will be quite modest in magnitude.

The optional heat exchanger 180 in the krypton refinery 102 provides a potential benefit by reducing the temperature of the crude krypton fed to the refining column 185 so that it is near in temperature to its dew point. As a result, the undesirable effects of the superheated feed are eliminated, and the amount of liquid nitrogen 186 addition to the condenser 195 needed for the separation to achieve high krypton recovery is reduced.

When the optional heat exchanger 180 is used, a portion of the vaporized nitrogen 177 from the condenser 195 may be vented as a cold gas vent stream 178 prior to entering the optional heat exchanger 180 since the liquid nitrogen 186 flow rate to the condenser 195 needed for effective performance of the refining column 185 exceeds the amount needed to balance the refrigeration. Venting the excess cold vapor 178 avoids very large temperature differences across the optional heat exchanger 180 that may exceed design constraints.

The condenser 195 is required at the top of the refining column 185. The condenser 195 is most likely to be refrigerated with liquid nitrogen 186, although liquid oxygen could alternatively be used based on availability. The pressure on the boiling side of the condenser 195 is controlled using the waste nitrogen valve 176A. The pressure control is modulated to maintain an appropriate temperature difference for proper functioning of the condenser 195.

The waste gas 177 exits the top of the condenser 195, as shown. A portion of the waste gas is optionally vented as a cold gas 178 while the remainder is directed to the optional heat exchanger 180. Upon exiting the optional heat exchanger 180, the warmed waste gas is decreased in pressure through a valve 176A and then vented to the atmosphere or used in some other application within the plant. As indicated above, valve 176A controls the pressure of condenser 195.

The refining column 185 requires between 5 and 15 theoretical stages of separation. The feed point is preferably at 1 stage to 3 stages below the top of the refining column. However, providing the feed directly at or near the top of the refining column is only modestly non-optimal. Hence, it may be preferred for the feed point to be at or near the top of the refining column 185, particularly if the distillation media is structured packing. In this case, the top feed point construction would avoid the cost of an additional liquid trough and redistributor. However, another design consideration must be whether feeding the vapor directly to the top of the refining column 185 could result in freezing since the feed vapor, without sufficient mixing with the rising vapor in the refining column 185, would likely freeze at the condenser temperatures.

The refining column 185 is configured to produce a refined krypton bottoms and a refining column overhead. A first portion of the refining column overhead is condensed in condenser 195 to produce a refining column reflux stream that is directed to an upper location of the refining column 185. The remaining portion of the refining column overhead is directed to the optional heat exchanger 180 and used to cool the crude krypton feed. Upon exiting the optional heat exchanger 180, the warmed waste gas is decreased in pressure through a valve 176B, which also controls the pressure of the refining column 185. As was the case for the crude distillation column 135, the refining column 185 pressure is controlled to prevent any possibility of freezing during operation. As such, the pressure of refining column 185 in krypton refinery 102 and the control thereof, can be similar to that of the crude distillation column 135 in the crude krypton recovery units 101.

A portion of the refined krypton bottoms is reboiled to produce an ascending vapor stream in the refining column. The bulk of the refined krypton bottoms, however, are extracted from the bottom of the refining column 185 to yield the refined krypton product. Any nitrogen and oxygen impurities in the refined krypton product are removed in the optional post processing contaminant removal or purification unit 196 to very low concentrations required by the krypton product customers. The purified, refined krypton product or krypton product stream is then compressed in krypton product compressor 197 and one or more product containers 198 are filled with the compressed, krypton product.

FIG. 2 is a graph 200 illustrating crude distillation column fluid conditions versus krypton (in nitrogen) melting point data (curve 203) according to an embodiment of the present krypton recovery system and method. In FIG. 2, the x-coordinate 202 is krypton mole fraction and the y-coordinate 201 is the temperature, in Kelvin, of the krypton (in nitrogen). The curves illustrate the krypton composition in the crude distillation column vs. its temperature from near its feed condition (i.e. krypton composition of approximately 1000 ppm—mole fraction of 0.001) at the top to its final product composition withdrawn from the sump at column pressures of 70 psia or 75 psia.

pSeveral reasonable design cases are illustrated in FIG. 2 for the crude distillation column, based on a feed containing krypton in nitrogen, with no other components. These cases maintain a safety margin from the freezing point curve to account for operating variations and possible uncertainty in the freezing point (i.e., also referred to as the melting point in FIG. 2). The crude distillation column pressure is a minimum of 70 psia for a crude krypton purity of 58%. For higher product purities the crude distillation column pressure is raised to 75 psia to maintain a safety margin from freezing within the crude distillation column. A higher pressure will yield a larger margin from the freezing point curve. Beyond the reasonable margin needed to maintain stable operation, however, higher column operating pressure increases the power required for the feed compressor and further reduces the practically attainable limit of crude krypton purity. Operating at a lower crude column pressure will further reduce the crude krypton purity below 58% to maintain a margin from the freezing point curve.

It is probable that a small amount of oxygen is contained in the mixture (<2%), as previously mentioned. Oxygen is less volatile than nitrogen and will tend to increase in concentration near the bottom of the column. With the column pressure unchanged, higher oxygen content in the reboiler will raise the reboiler temperature and the required pressure of the krypton containing feed. However, a design anticipating oxygen in feed will preferably use a reduced crude distillation column pressure. In fact, the melting point curve of krypton-oxygen shows that freezing occurs at a lower temperature than krypton melting point in nitrogen curve 203 for mixtures. Thus, a design anticipating oxygen in the feed can be operated at a pressure reduced such that the reboiler temperature is somewhat reduced, and the feed pressure is lower for a given crude krypton purity. The result will be a lower feed compression power yielding operational cost savings.

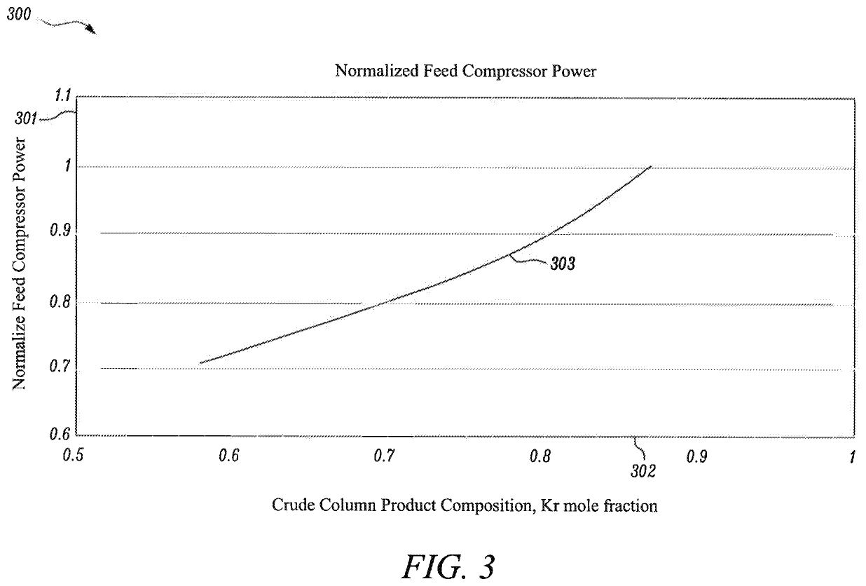

FIG. 3 is a graph 300 illustrating feed compressor power on the y-coordinate 301 vs. crude distillation column product purity on the x-coordinate 302, according to an embodiment of the present krypton recovery method and apparatus. As seen in FIG. 3, the normalized feed compression power is shown and the curve 303 indicates a greater increase in power 301 as the purity 302 increases. The increase in purity 302 corresponds to a modest reduction in shipping volume and cost. The crude krypton will likely be transported to another facility for final purification. The cost relationship of compression power vs. shipping will guide the optimization of crude krypton purity. The increasing rate of power consumption with purity is due to a more rapidly increasing trend in krypton containing feed pressure.

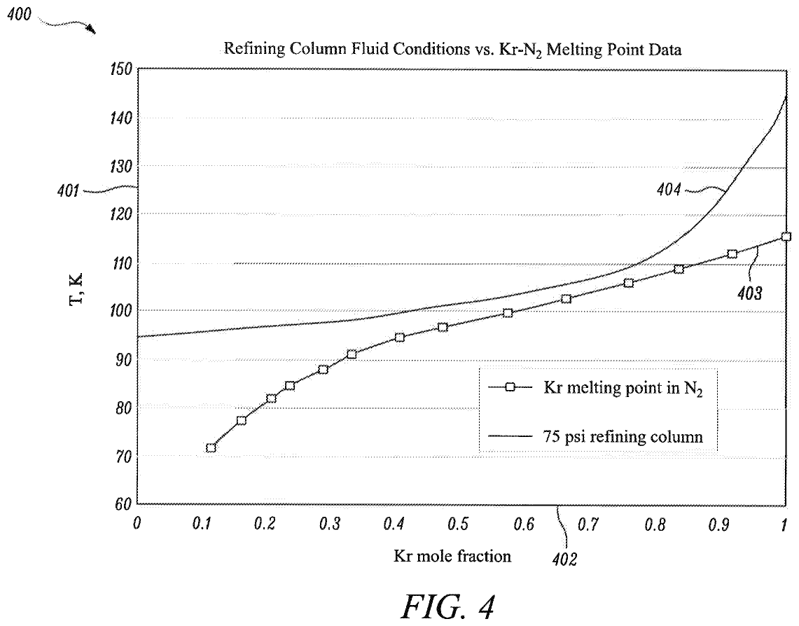

FIG. 4 is a graph 400 illustrating the fluid composition in the refining column versus temperature profile compared to the melting point curve 403, according to an embodiment of the present krypton recovery apparatus and method. It is noted that the refining column pressure can be higher with minimal process penalty. Since the reboiler is preferably an electric reboiler, its heat can be provided at the higher temperature needed for a higher column pressure. This would provide additional margin from freezing if so desired.

The condenser must also be considered as a location for freezing due to process fluctuations. For the 75 psia refining column operating pressure curve 404 of FIG. 4, the condenser cooling fluid will be about 92 K. It is apparent that a very large process upset would be needed to cause freezing in the condenser. In that case, the krypton composition would have to be about 35%. Also, operation with greater than even 1% krypton in the top of the column is undesirable due to the loss of krypton product.

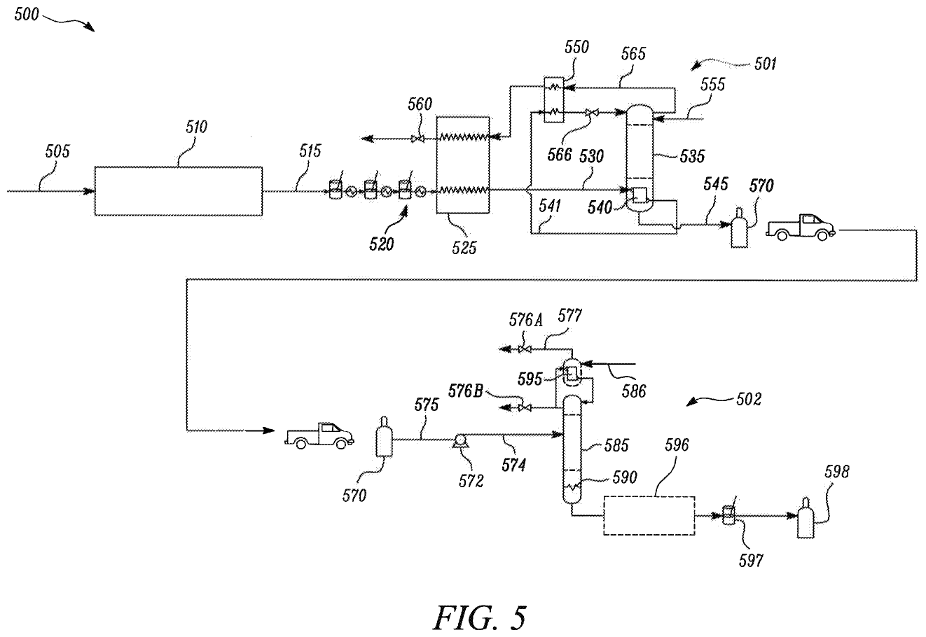

FIG. 5 illustrates another embodiment of the krypton recovery method and apparatus similar to that shown in of FIG. 1 but without conversion of crude krypton to a gas. Specifically, FIG. 5 is identical to FIG. 1 except crude krypton is not converted to gas for transferal to the refinery 502. Thus, the elements in FIG. 5 identical to those in FIG. 1 will not be described, for conciseness.

Note reference numerals 100, 101, 102, 105, 110, 115, 120, 125, 130, 135, 140, 141, 145, 150, 155, 160, 165, 166, 170, 175, 176A, 176B, 177, 185, 186, 190, 195, 196, 197 and 198 in FIG. 1 generally correspond to the same components and streams 500, 501, 502, 505, 510, 515, 520, 525, 530, 535, 540, 541, 545, 550, 555, 560, 565, 566, 570, 574, 576A, 576B, 577, 585, 586, 590, 595, 596, 597 and 598 in FIG. 5, respectively.

Since the refinery column 585 would operate at a similar pressure as the crude distillation column 535, a pump 572 is included to raise the pressure of the crude krypton feed liquid 574 prior to its feed to the refinery column 585. Alternatively, the crude krypton feed liquid 574 could be pumped at the crude krypton recovery units 501, prior to filling the product containers 570. The pump 572 may be omitted if the crude distillation column 535 can be operated at a somewhat elevated pressure or if there is elevation head to take advantage of in the feed of the crude krypton feed liquid 574 to the refining column 585. There may also be enough evaporation of liquid to naturally raise the pressure of the liquid containers without the need for the pump 572.

The cryogenic liquid feed configuration of FIG. 5 does not require use of the optional heat exchanger 180 of FIG. 1. With liquid crude krypton feed, the refining column condenser 595 is optional. Without the column condenser 595, the liquid crude krypton feed must be fed on the top tray of the refining column 585. The cost for the condenser 595 and the consumption of liquid nitrogen 586 (or oxygen) is avoided. There will be little or no risk for freezing of the fluid in the condenser, however marginal that may be. However, the recovery of krypton will be modestly compromised without the condenser 595.

When using the optional condenser 595, the liquid crude krypton feed point is preferably 1 stage to 3 stages below the top of the column. There may be practical or cost saving purpose for feeding the liquid at the top of the refining column 585, with a modest loss in krypton recovery. Overall, the refinery column 585 of FIG. 5 will require between 5 and 15 theoretical stages, similar to the refining column 185 in FIG. 1.

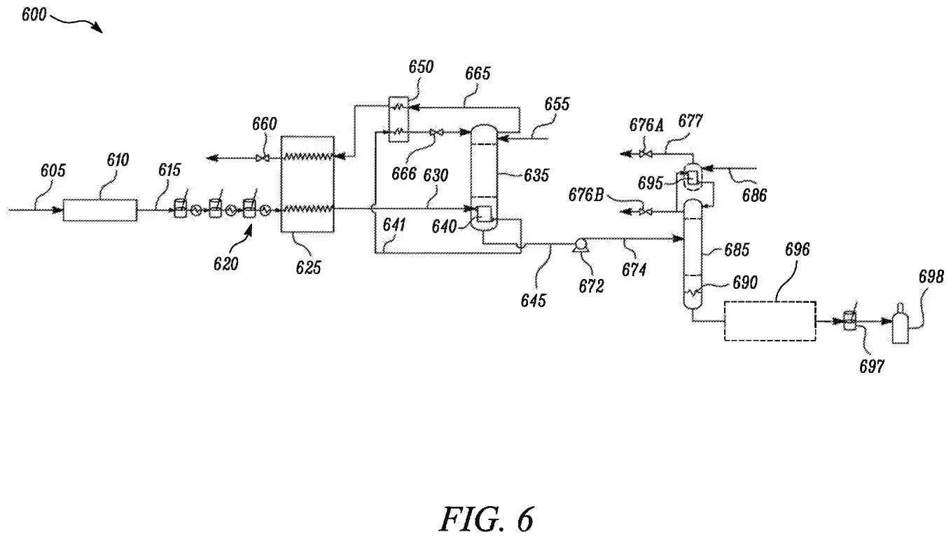

FIG. 6 illustrates yet another embodiment of the present krypton recovery method and apparatus with the entire system 600 at a unified location. Specifically, FIG. 6 applies to the less likely case that the crude krypton and refined krypton production are at the same location as the feed of krypton containing waste gas from the customer.

FIG. 6 is similar to FIG. 5; thus, the elements in FIG. 6 identical to those in FIG. 5 will not be described, for conciseness. Note reference numerals 600, 605, 610, 615, 620, 625, 630, 635, 640, 641, 645, 650, 655, 660, 665, 672, 674, 676A, 676B, 677, 685, 686, 690, 695,696, 697 and 698 in FIG. 6 generally correspond to the same components and streams 500, 505, 510, 515, 520, 525, 530, 535, 540, 541, 545, 550, 555, 560, 565, 572, 574, 576A, 576B, 577, 585, 586, 590, 595, 596, 597 and 598 in FIG. 5, respectively.

In FIG. 6, the crude krypton 674 is optionally pumped to be modestly repressurized before it is fed to the refinery column 685. If the crude distillation column 635 is operated at a somewhat elevated pressure, or if elevation head can be taken advantage of, use of the pump 672 can be omitted.

While the present disclosure has been described with reference to certain embodiments, various changes may be made without departing from the spirit and the scope of the disclosure, which is defined, not by the detailed description and embodiments, but by the appended claims and their equivalents.

What is claimed is:

1. A krypton recovery method, comprising:
(i) removing contaminants from a krypton containing waste gas to yield a krypton containing effluent gas;
(ii) compressing the krypton containing effluent gas;
(iii) cooling the compressed, krypton containing effluent gas in a first heat exchanger to yield a saturated vapor or nearly saturated vapor krypton containing effluent;
(iv) at least partially condensing the nearly saturated krypton containing vapor effluent in a reboiler against a krypton containing liquid to produce an at least partially condensed krypton containing fluid and an ascending vapor stream for a crude distillation column;
(v) directing the at least partially condensed fluid from the re-boiler to an upper location of the crude distillation column;
(vi) rectifying the at least partially condensed fluid in the crude distillation column to yield the krypton containing liquid at the bottom of the crude distillation column and an overhead;
(vii) extracting crude krypton from krypton containing liquid bottoms in the crude distillation column; and
(viii) refining the crude krypton to produce a refined krypton product.

2. The method of claim 1, wherein the reboiler is disposed in the crude distillation column.

3. The method of claim 1, wherein the step of cooling the compressed, krypton containing effluent gas further comprises cooling the compressed, krypton containing effluent gas in the first heat exchanger via indirect heat exchange against a waste gas extracted from the overhead from the crude distillation column.

4. The method of claim 3, further comprising the step of feeding a liquid nitrogen stream to the top of the crude distillation column.

5. The method of claim 3, further comprising: venting the waste gas to atmosphere, and wherein a valve is disposed at a warm end of the first heat exchanger and is configured to decrease a pressure of the waste gas before the venting of the waste gas to atmosphere.

6. The method of claim 1 wherein the step of refining the crude krypton to produce the refined krypton product further comprises feeding the crude krypton into a second heat exchanger configured to cool the crude krypton via indirect heat exchange with one or more cold gas streams in the second heat exchanger.

7. The method of claim 6, further comprising the steps of:
directing the cooled crude krypton from the second heat exchanger into a refining column configured to produce a refined krypton bottoms and a refining column overhead;
condensing a portion of the refining column overhead to produce a refining column reflux stream that is directed to an upper location of the refining column;
reboiling a portion of the refined krypton bottoms to produce an ascending vapor stream in the refining column; and
purifying another portion of the refined krypton bottoms to remove additional contaminants and yield a refined krypton product.

8. The method of claim 7, further comprising the steps of compressing the refined krypton product; and filling one or more product containers with the compressed, refined krypton product.

9. The method of claim 7, wherein the step of condensing a portion of the refining column overhead further comprises condensing the portion of the refining column overhead in a condenser against liquid nitrogen to produce the refining column reflux stream and a boil-off stream of nitrogen that is directed to the second heat exchanger as one of the one or more cold gas streams.

10. The method of claim 9, wherein another portion of the refining column overhead is directed to the second heat exchanger as another of the one or more cold gas streams.

11. A krypton recovery apparatus, comprising:
an adsorption based purifier configured for removing contaminants from a krypton containing waste gas to yield a krypton containing effluent gas;
a compressor configured for compressing the krypton containing effluent gas;
a first heat exchanger configured for cooling the compressed, krypton containing effluent gas to yield a saturated vapor or nearly saturated vapor krypton containing effluent;
a reboiler configured to at least partially condense the nearly saturated krypton containing vapor effluent against a krypton containing liquid to produce an at least partially condensed, krypton containing fluid and an ascending vapor stream;
a crude distillation column configured to receive the ascending vapor stream and the at least partially condensed, krypton containing fluid and to rectify the at least partially condensed, krypton containing fluid to yield the krypton containing liquid and an overhead;
a krypton refining system configured to receive crude krypton from the crude distillation column and produce a refined krypton product.

12. The apparatus of claim 11, wherein the reboiler is disposed in the crude distillation column.

13. The apparatus of claim 11, wherein the first heat exchanger is further configured to cool the compressed, krypton containing effluent gas via indirect heat exchange against a waste gas extracted from the overhead from the crude distillation column.

14. The apparatus of claim 13, further comprising:
a valve disposed at a warm end of the first heat exchanger configured to decrease a pressure of the waste gas; and
a vent configured to release the waste gas to the atmosphere.

15. The apparatus of claim 11, wherein comprising a source of liquid nitrogen fluidically coupled to the top of the crude distillation column.

16. The apparatus of claim 11, wherein the krypton refining system comprises a second heat exchanger configured to receive the crude krypton and cool the crude krypton via indirect heat exchange with one or more cold gas streams.

17. The apparatus of claim 16, further comprising:
a refining column configured to receive the cooled crude krypton from the second heat exchanger and a refining column reflux stream and produce a refined krypton bottoms and a refining column overhead;
a condenser configured to condense a portion of the refining column overhead to produce the refining column reflux stream; and
a purifier configured to remove additional contaminants from the refined krypton bottoms to yield a krypton product.

18. The apparatus of claim 17, further comprising an auxiliary compressor configured to compress the refined krypton product; and a filling system configured to fill one or more product containers with the compressed, refined krypton product.

19. The apparatus of claim 17, further comprising a condenser configured to condensing a portion of the refining column overhead against liquid nitrogen to produce the refining column reflux stream and a boil-off stream of nitrogen that is directed to the second heat exchanger as one of the one or more cold gas streams.

20. The apparatus of claim 19, wherein another of the one or more cold gas streams is another portion of the refining column overhead.
